(19) United States
(12) Patent Application Publication
(10) Pub. No.: US 2025/0095033 A1
(43) Pub. Date: Mar. 20, 2025

(54) SYSTEM AND METHOD FOR AMPLIFYING AND ENHANCING A DONATION OF CONSUMER INCENTIVE PROGRAM REWARDS

(71) Applicant: Andre Pastoriza Gruebele, Arlington, VA (US)

(72) Inventor: Andre Pastoriza Gruebele, Arlington, VA (US)

(21) Appl. No.: 18/369,103

(22) Filed: Sep. 15, 2023

(51) Int. Cl. G06Q 30/0279; G06Q 30/0207; G06Q 30/0226; G06Q 40/06; G06Q 40/10

(52) U.S. Cl. CPC G06Q 30/0279; G06Q 30/0215; G06Q 30/0227; G06Q 30/0233; G06Q 30/0236; G06Q 40/06; G06Q 40/10

(57) ABSTRACT

Systems and methods for incentivizing the accrual and donation of individuals' earned incentives from consumer incentive programs by optimizing and pairing those donations with other donations, including those of third parties, and additional incentive programs, promotions, campaigns, and offers to generate the highest yielding excisable donation to at least one donation recipient.

### FIELD OF THE INVENTION

The present invention generally relates to shoppers' and donors' (sometimes individually or collectively called “users”) donations to donation recipients (such as individuals, charities, nonprofit organizations/business, etc.) of both cash and non-cash assets or other consideration including rewards, loyalty, and/or other incentivizing programs (or merely “incentive programs”). More specifically, the present invention includes further incentivization of the donation of those cash and non-cash assets and other consideration by users through offering increased aggregated donation amounts by amplifying and/or enhancing users' contributions with other donations, third-party donors' matching donations, affiliate commissions and other assets generated by the platform and other incentive program rewards.

### BACKGROUND OF THE INVENTION

Today, shoppers are bombarded with rewards, loyalty, and other incentive programs, promotions, campaigns, offers, etc. from what sometimes seems like every store, online marketplace, and credit, pre-paid debit, and gift card issuer (collectively “providers”). It is easy for shoppers to lose track of their incentive programs and either let their accrued or provided benefits sit and stagnate or expire. This is a windfall for the incentive program providers and, while not necessarily so impactful to be deemed a detriment, is an annoyance and inconvenience for shoppers. There is a long-felt need for services that allow shoppers to extract and optimize value from their earned incentive rewards when they are unwilling or unable to redeem them for their own personal use.

In efforts to use (or potentially optimize) the incentive programs they participate in, some shoppers have turned to services, businesses, and programs or applications which assist them in maximizing their incentive accrual and usage. Some of these services and/or programs offer to optimize received benefits either by suggesting or converting shopper's accrued points, miles, rewards, or other incentive to the highest yielding extractable value (for example: when redeeming rewards points as a gift card provides more financial benefit than directly cashing out the rewards either as a check or credit to the shopper's account).

Other services may notify shoppers of time-limited incentive programs which typically offer increased incentives, temporarily available incentives, or both. Savvy shoppers take advantage of such time-limited incentive programs to maximize their extractable financial value.

Further, some services may offer further (or bonus) incentivized activity for what the shopper does with their accrued incentives. For example, services may offer increased incentives in the form of a better incentive-to-value conversion to the shopper when they redeem their incentives for gift cards, airline tickets during certain travel windows, or when donating to charity. For many shoppers, this adds some level of social pressure and/or motivation to donate their earned incentives (as well as directly donating cash and non-cash assets).

Charities and donors sometimes employ these incentivized donations and/or matching donations to encourage additional donations to said charities by a single donor or donors. (“Donor(s)” refers to individuals, groups, businesses, organizations, etc., essentially anyone, group, or legal entity which freely gives something of value to a charity.) Once donations are pledged and/or received, the challenges of confirming receipt, tracking, dispensing, and reporting often serve as hurdles or slowdowns for the operation of many donation recipients or platforms seeking to relay donations. These hurdles or slowdowns are compounded the more donation recipients there are receiving donations. Therefore, particularly for scale, there is a long-felt need for a platform which maximizes accrual of incentives for pairing as “amplified” and/or “enhanced” donations and which offers holding, tracking, dispensing, and reporting of donations for users, donation recipients, and other interested parties.

Further, by soliciting donations from donors and using those donations to incentivize shoppers to donate earned cash or non-cash incentive program assets, the platform creates a larger aggregated donation than would otherwise be possible if those donors donated through traditional avenues (i.e., outside of the platform). Donating via the platform results in the donors' donation having an outsized impact, shoppers gaining a new and more valuable redemption option for their incentives, and donation recipients receiving a larger donation than would have otherwise been achieved. Therefore, there is a long-felt need for a platform that amplifies and/or enhances the economic and social impact that shoppers/consumers, donors, companies, and others provide donation recipients by using aggregated donations and donation matching to incentivize and optimize the excised value from donations and/or incentive programs.

Put another way, additional value is generated and transferred to donation recipients by providing shoppers, donors, and third-party donors with a convenient and simple platform and method to indirectly interact, influence one another (using the platform as a medium), and contribute to charitable causes. Donation recipients are further benefited because it is less likely that the shoppers, donors, and third-party donors would donate as frequently or as large a donation without having the convenience and simplicity of the platform.

### SUMMARY OF THE INVENTION

The following presents a simplified summary of the present invention to provide a basic understanding of the invention's concepts. This summary is not an extensive overview, and it is not intended to identify critical elements or to limit the scope of this disclosure. The sole purpose of this summary is to present some general concepts in a simplified form as a prelude to the detailed description of the invention.

The subject matter disclosed and claimed herein, in some embodiments of the present invention, relates to a system for incentivizing and amplifying a donation of consumer incentive program rewards with third-party contributions, the system comprising: at least one provider; at least one user connected via at least one user device; at least one merchant; at least one donation recipient; a platform comprising: a network connection to the at least one provider, the at least one user, the at least one merchant, and the at least one donation recipient; a merchant system operably connected to the at least one provider and the at least one merchant, and providing at least one method for a shopper to engage with the at least one provider and the at least one merchant; a loyalty system that facilitates, engages with, and incentivizes the at least one shopper to donate the at least one shopper's earned incentive to the at least one donation recipient; a donor system that facilitates a donation from a donor to the at least one donation recipient; a promotional matching system that includes a promotion search module which finds, evaluates, scores, and records at least one promotion that may be used for the at least one shopper's accrual and donation of the at least one earned incentive to the at least one donation recipient; a donation amplifying system for matching, amplifying, and optimizing the at least one shopper's donated at least one earned incentive by incentivizing the shopper to make their donation through the platform in order to allow the donation amplifying system to combine the shopper's donated at least one earned incentive with the at least one donor's donation and at least one third-party donor's donation to create an aggregated donation that is greater than if the donor or third-party donor were to individually donate their respective donations without using the system; and a database.

The subject matter disclosed and claimed herein, in some embodiments of the present invention, relates to a method for incentivizing and amplifying a donation of consumer incentive program rewards with third-party contributions, the method comprising: a platform providing a donor with at least one method for making a donation to at least one donation recipient via the platform; the platform providing a third-party donor with at least one method for making a matching donation to the at least one donation recipient via the platform; the platform providing a shopper with at least one form of a loyalty system to engage with in order to generate an asset that may be donated to the at least one donation recipient; the platform incentivizing the shopper to donate at least one earned incentive to the at least one donation recipient via the platform wherein at least one of: the donor's donation and the third-party donor's matching donation are used to incentivize the shopper to donate the shopper's at least one earned incentive to create an amplified aggregated donation; the shopper donating the at least one earned incentive to the at least one donation recipient via the platform; the platform aggregating at least two of: the shopper's donated at least one earned incentive, the donor's donation, and the third-party donor's matching donation to create the amplified aggregated donation; and the platform causing the amplified aggregated donation to be sent to the at least one donation recipient.

To the accomplishment of the foregoing and related ends, certain illustrative aspects of the disclosed innovations are described herein in connection with the following description and the annexed drawings. These aspects are indicative of only a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The embodiments of the present invention disclosed herein are illustrated by way of example, and not by way of limitation, in the figures of the accompanying drawings, in which like reference numerals may refer to similar elements.

FIG. 1 is an exemplary embodiment of a system for incentivizing and amplifying donations with third-party contributions.

FIG. 2 is an exemplary embodiment of some components within the platform.

FIG. 3 is an exemplary method for amplifying shopper incentive donations.

FIG. 4 is an exemplary method of how the shopper may use the platform.

FIG. 5 is an exemplary method for scraping data to offer promotions to users of the platform.

FIG. 6 is an exemplary method for scraping donor data to offer promotions to users of the platform.

FIG. 7 is an exemplary method for scraping donation data provided by charitable organizations to offer promotions to users of the platform.

FIG. 8 is an exemplary method for obtaining employer promotion data and assisting users of the platform in benefiting from donation programs provided by their employers.

FIG. 9 is an exemplary method for finding, tracking, evaluating, and providing users of the platform with at least one donation promotion.

FIG. 10 is an exemplary method of donation amplification for shopper donations made via the platform.

FIG. 11 is an exemplary method of amplifying a shopper's incentivized donation.

FIG. 12 is an exemplary method of using a donor's donation to incentivize and amplify a shopper's donation.

### DETAILED DESCRIPTION OF THE PRESENT INVENTION

The innovation is now described with reference to the drawings, wherein reference numerals are used to refer to elements throughout. In the following description, for purposes of explanation, numerous specific details are set forth to provide a thorough understanding of the present invention. It may be evident that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As previously noted, there is a long-felt need for a system and/or method which maximizes financial and social impact for donation recipients by incentivizing shoppers and donors alike to donate their cash, rewards points, miles, gift cards, and other resources (collectively “assets”) to be matched and amplified with third-party donors' contributions to generate the largest donation. “Shoppers” includes commercial users of the platform and/or users that link their commercial activity on other websites or services to the platform's services. “Donors” includes individuals, groups, and legal entities who may choose to donate to donation recipients via the platform and/or provide details of their incentive programs for donations made to the platform. “Third-party donors” includes individuals, groups, and legal entities that provide contribution matching and/or other incentives to encourage shoppers and donors to donate via the platform. Third-party donors may also be “partners” of the platform. The same person, group, or legal entity could simultaneously be a shopper, donor, and/or third-party donor. Likewise, shoppers, donors, and third-party donors may be considered “users” of the platform because they interact with the platform.

Further, there is a long-felt need for a system and/or method that may pool these aggregated donations and contributions (whether all in the same or in various forms) so that an entity could leverage the aggregated donations, in all their forms (such as rewards points), to excise the largest benefit from incentive program owners to be given to donation recipients.

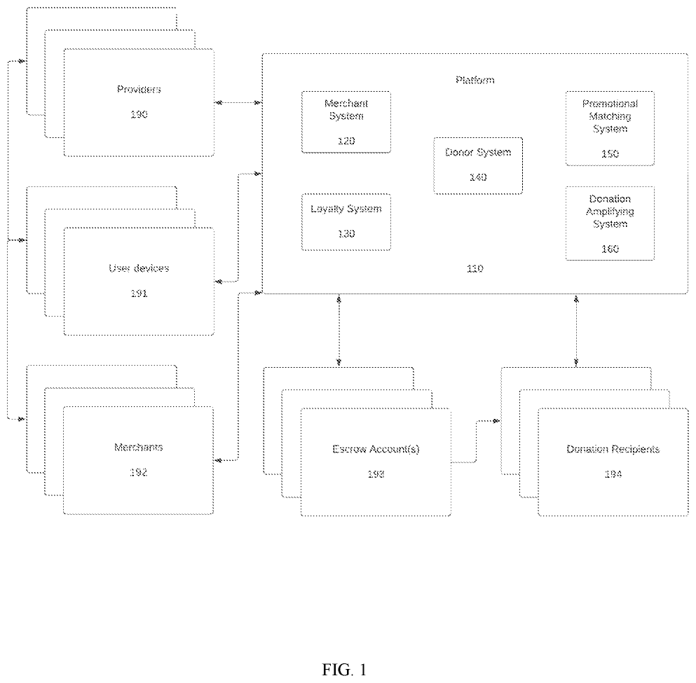

FIG. 1 is an exemplary embodiment of a system for incentivizing and amplifying donations of incentive program rewards with third-party contributions. In some embodiments of a system for incentivizing and enhancing a donation of consumer incentive program rewards (or merely “incentives”) with third-party contributions 100 (or merely “system 100”), a platform 110 facilitates the incentivized and amplified donation by a shopper and/or donor (either called a “user” as a general purpose name for an individual who engages with the platform 110) (via a user device 191) to a donation recipient 194. The platform 110 includes at least one computing device and/or server having typical components such as a computer processor, computer-readable memory, storage, a network connection and interface, sets of computer-readable instructions for executing and facilitating the platform's 110 operations, etc. Further, the platform 110 includes at least one merchant system 120, at least one loyalty system 130, at least one donor system 140, at least one promotional matching system 150, and at least one donation amplifying system 160. “Incentive programs” broadly and inclusively being one form of a promotion, campaign, loyalty program, rewards program, customer retention program, or any other system, program, or process set up to allow shoppers and/or donors to gain something of value (monetary, social, spiritual, etc.) for participation in an incentive program owner's promoted activity. Third-party contributions include a donation of the same type as the user (“amplification”) or a different type of donation (“enhancement”).

The platform 110 is accessed by and/or communicates with providers 190, users through user devices 191, merchants 192, and donation recipients 194 via a network and may serve as a hub for communication between each of those individuals and/or groups. The platform 110 also uses at least one escrow account 193 to deposit, track, and eventually disperse donations to the donation recipients 194. The platform 110 may be operated by its owner, their agents, and other affiliates of the owner. When referencing “the platform 110” as an actor or agent throughout this disclosure, it should be understood that actions taken by the platform may be performed by automated processes, an individual, a group of operators, or combinations of varying degrees thereof. The at least one escrow account 193 is owned by a financial institution who provides said banking, escrowing, and other services to the platform 110.

In alternative embodiments, donations (including incentives, rewards points, money, and other items) may be sent directly to the donation recipient. It should be appreciated that in this embodiment the platform 110 has less accounting and overhead concerns, among other considerations, when operating to provide shoppers, donors, third-party donors, and donation recipients the benefits of using the platform 110. Further, in these embodiments, donation aggregation may occur via a third party's efforts or naturally as shoppers, donors, and third-party donors pledge and/or donate to the donation recipient(s). In these embodiments, the platform 110 acts as a facilitator for the shoppers, donors, and third-party donors' donations to the donation recipient 194 and maintains very little control over the donations made and their transference from one party to another.

In further alternative embodiments, pledged donations from shoppers, donors, and third-party donors may be put on hold and/or called to collect once the aggregated donation is able to be created, at certain times/days, when thresholds are met, or under other conditions as set by the platform 110, the donation recipients 194, the shoppers, donors, and third-party donors, or other interested party. For example, instead of transferring the funds from a third-party donor to be matched with shoppers and donors' donations to the escrow account operated by the platform 110, the funds may instead be put on hold in the third-party donors' account or payment method. Then, when a threshold of shoppers and/or donors' donations are reached, the platform 110 may request the release of the held donation so that it may be transferred to the donation recipient 194.

The at least one merchant system 120 creates, tracks, and facilitates the commission relationships between service, promotion, campaign, incentive, and rewards providers (or “providers”) and/or third-party commercial partners (or “merchants”) for the generation of at least one incentive that at least one shopper earns and provides as a donation to at least one donation recipient 194. Generally, providers offer incentive programs to shoppers and merchants are retail websites or spaces for goods and services that are offered to shoppers. Providers may also be merchants, and vice versa. Providers may often be credit card (one form of a “payment instrument”) and/or store card issuers because one of the most used forms of incentive programs is credit card/store card rewards points. The platform 110 acts as a method for shoppers to engage with at least one provider and at least one merchant (again, the provider and the merchant may be the same entity). Shoppers may have direct contact with providers and merchants without using the platform 110; however, this may hinder the optimization, accrual, tracking, and donation of the shoppers' acquired incentives from incentive programs.

In some embodiments, the at least one loyalty system 130 provides shoppers with a multitude of URL links, internet links, or merely “links” (such as affiliate links to merchants and/or normal links to providers) to websites, marketplaces, applications, or other commercial avenues (collectively, “websites’) that allow shoppers to shop for products and/or services from the merchants while enjoying the benefits of their registered incentive programs when the merchant is also a provider. These are all exemplary embodiments wherein the loyalty system facilitates the shopper's engagement with providers and merchants. On the customer-facing side, in some embodiments, the loyalty system 130 provides at least one incentive (aka one form of an asset that may be donated) via at least one incentive program module. In some embodiments, shoppers do not have to register an account on the platform 110 to benefit from the incentives present on the platform 110. This is typically accomplished by the platform 110 having agreements with merchants and providers to reward unregistered shoppers with incentives when the shoppers are transferred to the merchants' and providers' websites via affiliate links on the platform 110. In further embodiments, the platform 110 is operably connected with merchants and providers to receive commissions from unregistered shoppers who visit the websites by non-affiliate link means (in such a case the shopper may notify the website of the platform's 110 involvement in directing the shopper to the website).

In alternative embodiments, the loyalty system 130 may provide the aforementioned incentive by directing the shopper to sign into the shopper's registered account on merchant's website which is populated when the shopper interacts with the affiliate link. If the shopper does not have a registered account with the merchant linked to the affiliate link, the shopper is prompted to either create a new registered account with that merchant or, alternatively, use other login credentials by connecting their Google account, Apple account, or account with the platform 110 using known security gate and login APIs.

In further alternative embodiments, the platform's 110 loyalty system 130 may facilitate one or more of the following (instead of, or in addition to, providing links): track the shopper's use of their credit card or other payment method, track the shopper's interaction with online services other than the platform 110 (including gaming services, travel services, memberships with other services, completion of online surveys, rewards for turning in unused gift cards, new account/user referrals to services/businesses, etc.), and/or the loyalty system 130 may monitor and derive compensation via other user consented methods in order for the platform 110 to track and receive the shoppers' earned incentives and for the platform to receive compensation for the platform's 110 part in connecting the shopper with other providers, businesses, services, merchants, stores, etc. As an example of this alternative loyalty system 130, the platform 110 may partner with a credit card issuer (such as a bank or other financial institution) where the shopper's purchases using the credit card linked to the platform 110 includes at least one agreement where the card issuer provides a portion of the collected transaction and/or processing fees to the platform 110 (either as a financial incentive or as assets to be used for donations or incentivizing donations). As another example of the loyalty system 130, the platform 110 may direct the shopper to a travel service which the platform may receive a commission based on the interaction and/or spending of the shopper. These alternatives to links with affiliate commissions may also be part of the merchant system 120.

The at least one donor system 140 facilitates the processes allowing at least one donor to make at least one donation to at least one donation recipient 194 via the platform 110. Donors are merely any user, partner merchant, or other individual, group, or legal entity that makes a donation to the at least one donation recipient 194 through the platform 110. Likewise, the donation recipient 194 may be an individual person, a group of people, or another legal entity (such as a charity, nonprofit organization, political party, etc.) which received the donor's donation.

The at least one promotional matching system 150 identifies and facilitates the incentivized and amplified donation by shoppers, donors, and third-party donors to donation recipients 194 by, generally, pairing and maximizing donations from donors with at least one separate, third-party donor that is identified and petitioned to also donate to the same donation recipient 194 that is receiving the shopper's and/or donor's donation. An “amplified” or “enhanced” donation generally means that the donation from the donor is having additional financial value (which may be in the form of cash, credit, promotional balances, points, miles, hotel stays, etc.) added to the donation by the platform or a third party. “Amplified donation” generally means that the third-party donation is of the same type as the original donation (i.e., gift card matched with gift card) while “enhanced donation” generally means that the third-party donation is of a different type as the original donation (i.e., cash matched with gift card). Further, “amplified donation” is generally used to encompass both amplified and enhanced donations in aggregate. For an example of an amplified donation: if the donor is donating $10 to a charity, the amplified donation may be that the charity receives $20 because the donor is paired with a matching donation program of one third-party donor. Amplified donations are most often available because third-party donors sometimes run matching or incentivized and/or amplified/enhanced donation programs to encourage donations to certain donation recipients 194 (such as Amazon offering up to $5 as a matching donation when certain items are purchased and when the donation benefits a charity such as the Red Cross).

The at least one donation amplifying system 160 includes the rules and computer-readable sets of instructions which facilitate the amplification/enhancement of donations to the donation recipients 194. Further, the donation amplifying system 160 aggregates the incentive programs of shoppers, donors, and third-party donors (who are solicited or engage with the platform 110 as a donation matching donor) alike to maximize the financial value of the donation to the donation recipient 194. In some embodiments, the donation amplifying system 160 keeps a database of pledged donations from donors and/or third-party donors that are used to incentivize shoppers of the platform 110 to make purchases via the affiliate links on the platform 110 by asserting that any incentives generated and/or donated to any or select donation recipients 194 will be “matched” at a match rate that is set by the donor and/or third-party donor. Further, the donor and/or third-party donor is often free to set the parameters of their incentivized donation programs such as the timeframe and/or duration of the program, a minimum donation required to trigger a matching donation, a cap on the total donation that the third-party donor will donate, who is eligible to participate in the incentivized donation program, whether the match rate is set or variable based on certain criteria or factors, geographic restrictions, and more.

In some embodiments, shoppers may be incentivized to participate in donating to the at least one donation recipient 194 by using other shoppers' donations to incentivize a new shopper's donation (for example, an incentive campaign encouraging the shopper to join other shoppers like them in donating to a specific donation recipient).

Regardless of whether the donation comes from a shopper, donor, third-party donor, or other source, the collective feedback loop of donating is used to encourage and incentivize users and potentially non-users of the platform 110 to donate.

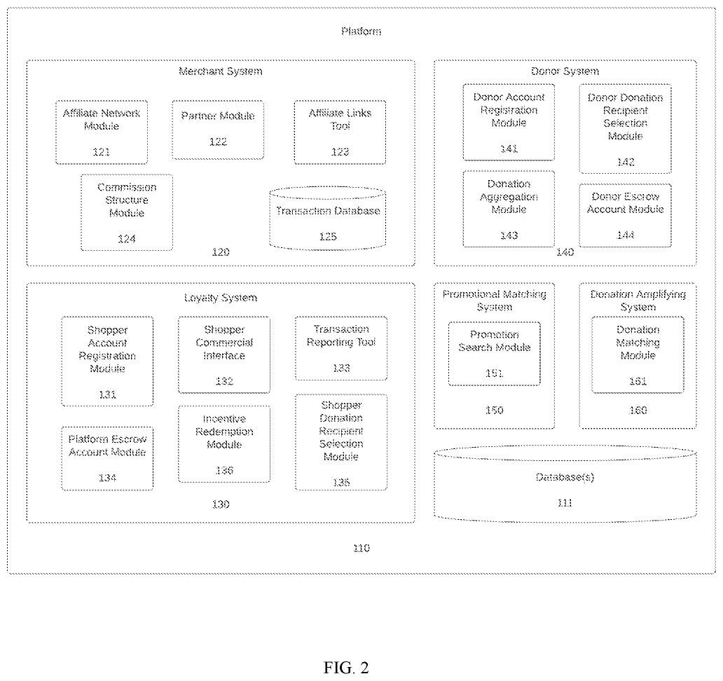

FIG. 2 is one exemplary embodiment of some of the components within the platform. It should be noted that the platform 110 should include at least one database 111 (shown as part of the platform 110; however, external database services may be employed). This database 111 may store user account data for the platform, loyalty system 130, donor system 140, user preferences, user personally identifiable information, and other useful information.

In some embodiments, the merchant system 120 includes an affiliate network module 121, a partner module 122, an affiliate links tool 123, a commission structure module 124, a transaction database 125, and other necessary server and/or computer system components to enable the merchant system 120 to operate and communicate with the other systems of the platform 110. The affiliate network module 121 establishes communication between partners and their affiliate marketers. The platform 110 itself may serve as a partner, affiliate marketer, or merely a facilitator between the two which provides affiliate links and incentive programs to the shoppers.

The partner module 122 facilitates communication between the platform 110 and at least one financial and/or retail partner. This module may further keep information about the relationships between the platform 110 and the merchants and/or providers (such as terms of their contract, account balances due or owed, etc.). This communication may be necessary when the partner module 122 provides shoppers with more than only the corresponding affiliate link to the financial and/or retail partner's website. The affiliate links tool 123 stores and provides affiliate links on the platform 110 to shoppers and maintains those active links to the partner's websites. The commission structure module 124 communicates between the partner sites, affiliate marketers, and the platform 110 to calculate and record earned affiliate commissions. Customer and transaction data may be stored in the transaction database 125 which may be separate from the platform's primary database or databases 111. In some embodiments the transaction database 125 is unique to each partner, merchant, and/or provider and may be maintained by the platform 110, that partner, merchant, and/or provider, or a third-party database host.

In some embodiments, the loyalty system 130 includes a shopper account registration module 131, a shopper commercial interface 132, a transaction reporting tool 133, a platform escrow account module 134, a shopper donation recipient selection module 135, and an incentive redemption module 136. The shopper account registration module 131 guides shoppers through logging in or registering a new account on the platform 110. In addition to the creation of an email/username/phone number and password, the shopper account registration module 131 may collect additional information from the shopper such as their payment details, shipping information, and authorization to share said details and possibly others with the platform's 110 affiliated websites and/or partnered merchants, providers, and other parties. The centralization of the account on the platform 110 may be combined with authorized login credentials on other websites linked with the platform 110. This provides shoppers with one centralized login and only one place where a particular shopper stores their payment method for use on affiliated websites.

In some embodiments, the shopper commercial interface 132 includes a plurality of affiliate links, buttons, interactable fields or graphics, or other methods to access websites of partnered retailers and services (or merely “partnered websites”). Shoppers should access these partnered websites through the shopper commercial interface 132 to ensure that the platform 110 is able to track their accrual of incentives for use as donations on the platform 110. The aforementioned tracking of shopper spending on the partnered websites may be handled by the transaction reporting tool 133. The transaction reporting tool 133 may receive and/or transmit shopper spending to the platform 110 via common methods such as receiving the data from the partnered websites, through a plugin or application on the shopper's device or in the shopper's browser, or other networked means.

In some embodiments, when the shopper shops at partners of the platform 110, some partners may provide a commission and/or make a contribution to at least one donation recipient 194 or to a general fund for donations that is held by the platform 110. These contributions are sent by a platform escrow account module 134 to at least one of the platform's 110 dedicated escrow accounts 193 and may later be donated to at least one donation recipient 194 that is selected by the shopper, the partnered website's owner, or the platform's 110 owner. In most cases, unless the commission or contribution from the partner is specifically provided for a specific donation recipient 194, the collection on commissions or contributions to the escrow account 193 may be used to provide incentives to shoppers to donate to specific charities or as a fill-in donation if any specific amplified donation campaign is lacking donations in order to provide shoppers with the proposed amplified/enhanced donation rate, amount, or multiplier. In some embodiments, some portion of the commission and/or contribution received from the partnered website may be used by the platform 110 for operation costs and other expenses. Any assets held in the at least one escrow account may accrue interest which may be used to further incentivize donations, invested in long-term or short-term investments, or otherwise be lawfully used by the owner of the escrow account (typically the platform 110). The platform 110 may seek to use the assets within any escrow account or the interest for that account for investing to maximize donations to donation recipients 194.

The shopper may be given a choice to select their desired donation recipient 194 via an interface for the shopper donation recipient selection module 135. This tool may, most commonly, be in the form of an interface that provides the shopper with a set of approved donation recipients 194. Further, this tool may be used prior to the shopper shopping via the affiliate links when the partnered website owner does not require their commission or contribution to be sent to the partnered website owner's desired donation recipient 194. Even further, aside from commissions or contributions from partnered websites, the shopper donation recipient selection module 135, in conjunction with the incentive redemption interface 136, allows the shopper to select which donation recipient 194 will receive the shopper's earned incentives. Of course, the shopper is also able to elect, via the incentive redemption interface 136, to receive their own redemption if the shopper decides not to donate them to any donation recipient 194. However, shoppers will almost always not receive the promoted, incentivized redemption value of their earned incentives when redeeming their earned incentives to themselves instead of donating the incentives. Put another way, in most cases, shoppers who redeem their earned incentives for their own benefit will receive their enrolled incentive programs' baseline reward redemption values. In even further embodiments, the shopper may opt to consent and allow the platform 110 to donate the shopper's earned incentives as determined by the platform 110 or by a set of rules, policies, and/or guidelines the platform 110 follows (such as the platform donating the shopper's earned incentives to the donation recipient 194 which would maximize the redeemed donation amount). The donation recipient selection module 135 may create value by ideally provide notice and incentivization to encourage shoppers to donate when normally shoppers would either not think about donating, did not realize they had resources to donate, or did not know of an outlet to receive their donations.

The donor system 140 may include a donor account registration module 141, a donor donation recipient selection module 142, a donation aggregation module 143, and a donor escrow account module 144. In some embodiments, the donor system 140 provides the donor with a form, donation gateway, or other user interface (typically as part of the donor donation recipient selection module 142) that facilitates the donor's donation to at least one donation recipient 194. This form, gateway, or interface supplies the donor with requests for information that is legally required as well as a payment or donation gateway for the donor to donate their funds, incentives, etc. Further, the form, gateway, or interface may ask for supplemental information for tracking, context, relaying donation amplification data, marketing, and/or other purposes. Many donors wish to refrain from providing contact information online due to the potential for such information to be shared with affiliates, associates, partners, etc. from the entity receiving the donation. The donor's contact information may be undesirably (from the donor's perspective) used for solicitation or marketing, or other unwanted contact. This may even cause some donors to not donate to charitable causes; therefore, the platform 110, in ideal embodiments, will require as little information from the donor as legally possible and may attempt to restrict 3^{rd} party access to this information to maintain donor privacy and/or anonymity.

In alternative embodiments, donors may be required to register for a donor account on the platform 110 via the donor account registration module 141 to donate via the platform 110. This module may be part of the same account registration system (or communicatively connected to it) as the loyalty system's 130 shopper account registration module 131 or it may be a separate, but linked, account. Likewise, the donor system's 140 donor donation recipient selection module 142 may be the same tool as the shopper donation recipient selection module 135 used in the loyalty system 130, they may be linked, or they may be separate tools and/or interfaces.

In some embodiments, the platform 110 relies on the donation aggregation module 143 to calculate, receive, track, maintain ledgers, provide reports, and dispense the correct donation amounts from one or more escrow accounts 193 to the correct donation recipients 194. The purpose of the donation aggregation module 143 is to make the accounts and receiving/sending of donations trackable and more manageable, but this mostly depends on several factors including the number of donors and donations, the number of donation recipients 194, the frequency of receiving incentives, donations, contributions, commissions, etc. to the escrow account(s) 193, the frequency of disbursement of the incentives, donations, contributions, commissions, etc. to the donation recipients 194 from any escrow accounts 193, the financial/banking policies, caps, or regulations, and for reporting concerns. Regardless, the donation aggregation module 143 must include tracking of all received incentives, donations, contributions, commissions, etc. It may further include tools to notify the sending party that their incentives, donations, contributions, commissions, etc. have been received. It must also include its own, or access to, a database and tools for tracking all balances (financial, points, miles, hotel stays, and other incentives) for reporting or other purposes that are the responsibilities of the owner of the platform 110.

In some embodiments, the donation aggregation module 143 in conjunction with the donor escrow account module 144 primarily serves to collect, track, manage, and dispense incentives, donations, contributions, commissions, etc. from multiple donors for one specific donation recipient 194.

The donor escrow account module 144 may maintain, report for, and/or manage one or more of the escrow accounts 193 that the platform 110 uses to store donations for any donation recipient 194. In some embodiments, the donor escrow account module 144 and the platform escrow account module 134 may use the same escrow account 193. The aggregation of donations, commissions, benefits, contributions, etc. into fewer escrow accounts 193 than there are donation recipients 194 may come about as a practicality because it may be more efficient on system, network, and/or banking resources for the platform 110 to send allocated donations to donation recipients 194 on set time intervals, at set donation amount thresholds, from fewer escrow accounts 193, and by other policies or rules. In alternative embodiments, some, or all donation recipients 194 may be assigned their own or placed within a group escrow account 193.

In some embodiments, the promotional matching system 150 includes a promotion search module 151. The promotional matching system 150 primarily serves two purposes: (1) to find promotions and incentive programs for the platform 110, its shoppers, donors, donation recipients, and the platform's 110 partners, and (2) optimizing the financial and non-financial benefits for the shoppers and their donations to donation recipients 194.

The promotion search module 151 may consist of several mechanisms varying in complexity and degree of effort required by the platform 110 owner or an employee, volunteer, or representative. In the most time-demanding embodiments, the promotion search module 151 may include tools for individuals to manually search and apply for promotions for incentive programs from various retailers, service providers, card issuers, and other organizations. Further, the individuals may then have to input the criteria, authorization, credentials, and other data for the platform 110 to participate in and offer the found promotion to the platform's 110 shoppers. Further, the platform may have additional manual upkeep, maintenance, and reporting items to consider when complying with the terms of any found promotion, applicable laws, reporting requirements, and other encumberments. More complex embodiments of the promotion search module 151 will seek to automate as much of the process as possible as well as increase the overall efficiency of promotion discovery, submitting applications, tracking and maintaining records, and displaying promotions within the platform 110 for the shoppers and platform 110 owner's benefit. These more complex embodiments may introduce programs and/or algorithms suited for scraping data from the internet (including social media, web search results, emails, and so on) for promotions, incentive programs, campaigns, etc. collectively “promotions”), determining whether any promotion is of sufficient benefit and/or financial value to be offered to shoppers on the platform 110, identifying whether the promotion rules and policies are executable by the system (this may require human review and approval), recording the relevant promotion details for the platform 110, and providing the promotion details to the platform 110 and its shoppers. Determining whether any promotion is of sufficient benefit and/or financial value to be offered to the shoppers on the platform 110 may include assigning a score (based on set criteria) to each promotion and having a person or piece of software determine whether the promotion is suitable for the platform 110.

The donation amplifying system's 160 primary purpose is to combine donations and promotions from a variety of sources to maximize the donations sent to donation recipients 194 (or donation “amplification”) while also removing some of the complications and/or frustrations that some incentive programs cause users. Those complications and/or frustrations sometimes go so far as to disincentivize the user from maximizing the highest yield from an incentive program. (Incentive program owners may benefit from such complications and/or frustrations because it lowers their excisable value (or output) to the user.) One complication/frustration may sometimes take the form of obfuscating (whether intentional or unintentional) the highest yield that someone enrolled in the incentive program could extract from their earned incentives. For example, converting earned incentive points into a prepaid debit card to be sent to a physical address or mailbox causes a delay in the user being able to use the earned incentive; therefore, the user may opt to convert the earned incentive into another extractable value with a more immediate use (such as store credit). The donation amplifying system 160 removes many of these complications and/or frustrations by handling the optimization of generating the highest yield of excisable value from every participating incentive program. Further, by aggregating incentive rewards from multiple shoppers and/or donors, the platform 110 may arrange for incentive program owners to amplify or enhance the donations to maximize their impact for non-financial benefits (such as reputational benefits). Therefore, the donation amplifying system 160 is ideally creating value (i.e. donations) that would not have otherwise been transferred to the donation recipient 194 (again, through any combination of factors such as ease of use, convenience, social pressure, moral obligation, and others).

Optimizing the amplification of donations most often is accomplished by a mix of manual inputs of preferences along with tools, programs, and/or algorithms that calculate and organize incentives, donations, and matching funds to generate the largest amplification to donations for the at least one donation recipient. A few examples of the manual inputs of preferences includes setting lower and upper thresholds (or even minimums and maximums) for the rate of matching or a cap on donation matching provided by partners, setting sliding scale rules for the rate of matching, prioritizing selected donation recipients 194, setting durations of promotions, setting deadlines for donations and matching donations, and generating statistics, infographics, reports, or other materials to drive and/or incentivize additional donations and matching donations. Typically, these preferences will be set by the owner and/or an operator of the platform 110; however, some of the preferences may be set by third parties (such as partners), groups of users, donation recipients 194, etc. For example, a partner may pledge up to $500,000 in matching funds to be donated to a specified donation recipient 194 at a match rate of 50%. In this example, it will likely not be the partner inputting the preferences but the partner submitting these preferences to the platform 110 which will be approved or denied by a representative of the platform.

The donation amplifying system 160 includes a donation matching module 161. The donation matching module 161 retains a list of the platform's 110 partners who have pledged, allocated, and/or provided matching funds to be paired with at least one shopper's and/or donor's donation. Further, the donation matching module 161 may include optimization tools, programs, and/or trained algorithms that pair the partners' donations with users' (shoppers and/or donors) donations. Importantly, “matching funds” and “matching donations” does not necessarily mean that any partner, donor, and/or third-party donor are donating funds at a one-to-one ration, but rather that the partner is pledging a donation of some value in combination with the user's donation. For example, the partner may pledge to match up to $5 of the user's donation at a 100% match rate, up to a 50% match rate of the user's donation (uncapped), a combination of a capped amount and rate of matching, etc. The donation matching module 161 is also responsible for requesting, receiving, and/or moving the partner's funds to the proper escrow account to be paired with the shopper's donation and/or donor's donations before being sent to the donation recipient in one batched donation.

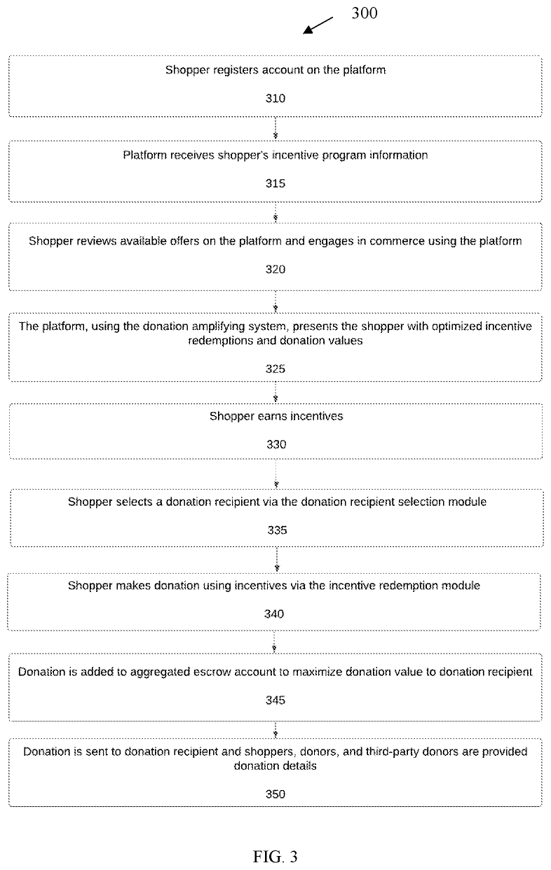

FIG. 3 is an exemplary method for amplifying shopper incentive donations. In some embodiments, a method for amplifying the donation of incentives from shoppers 300 begins like most other online platforms, applications, and services. Specifically, shoppers may be encouraged to register an account on the platform 310 to maximize their use of the platform's 110 offerings, services, and promotions. However, in many embodiments, the shopper is not required to register an account on the platform 110. Also, the platform 110 is incentivized to advertise its offerings, services, and promotions to individuals and groups that visit the platform 110 prior to registering their account. Therefore, the account registration step may occur at several points throughout the method for amplifying the donation of incentives 300, if at all. Again, account registration may be an optional step because, as previously described, the movement of shoppers to websites via affiliate links on the platform 110 will sufficiently allow the platform 110, in some embodiments, to receive commissions from the merchants and/or providers connected with their respective affiliate links.

Whether the shopper registers an account or not, the platform may be provided the shopper's incentive program information either from the incentive program owner or from the shopper 315. The incentive program owner may provide the shopper's incentive program information when the shopper engages in commerce via the affiliate link or through some other channel based on operable connections between the platform 110 and the incentive program owner. Additionally, even without registering the account, the shopper may be able to provide their incentive program details which then may or may not be verified with the incentive program owner. Having the shopper's incentive program information available to the platform 110 with little time and effort and without requiring the shopper to register an account is a very attractive arrangement for many shoppers.

In alternative embodiments, if the shopper registers an account with the platform 110, the shopper may then be prompted to link their incentive programs to their account. In most cases, the shopper will only be able to link their active incentive programs. Further, the platform 110 may offer new and/or expired incentive programs that the shopper is eligible for based on at least one eligibility criteria.

Linking incentive programs with the shopper's account on the platform 110 is accomplished, when possible and desired, through login credentials or authorization to access the linked incentive program's information regarding the shopper and/or their incentive program participation. In many cases, incentive program owners will already have software and network mechanisms to send and/or receive the shopper's incentive program data to/from third parties (such as the platform 110 in this instance) which allows those third parties to display the shopper's earned incentives, accrual rates, dates of disbursement, renewal, and expiration, eligibility for promotions, and other data related to the shopper and their incentive program(s). Further, if the incentive program owner does not currently have automated mechanisms to report on the shoppers' incentives and enrollment in the owner's incentive programs, the platform 110 may provide intake mechanisms or request the shopper's data.

The shopper reviews available offers and engages in commerce via the platform 320. The platform 110 may include promotions, marketing materials, links to partner websites, links to third parties, affiliate links, suggestions, advertisements, and other information that encourages the shopper to engage in optimized accrual and amplification of donated incentives.

The platform 110, using the donation amplification system 160, presents the shopper with optimized incentive redemptions and donation values 325. This creates value by alerting the shopper that their donations could benefit the donation recipients and may be of more financial value to those donation recipients than if the shopper redeems the incentive redemptions for themselves. In some embodiments, the shopper is presented with a plurality of optimized incentive redemption offers that may allow for the donation to be in different forms such as cash, a pre-paid debit card, gift cards, rewards points, loyalty points, travel miles, hotel accommodations, discounts, or other forms of incentives. Some or all the incentive redemption offers may include amplified and/or enhanced donation amounts that include matching, paired, or aggregated donations. While an aggregated donation is already amplified and/or enhanced it may then be further optimized with promotions to generate even further amplifications by leveraging the aggregated donation to excise more value from at least one promotion. Consider an example wherein a shopper donates rewards points that are aggregated with a donor's donation of rewards points and a third-party donor's donation is used to match the excised value. The donation amplifying system 160 may be able to (1) redeem rewards points at a higher value when in aggregate than if redeemed for shoppers and donors separately, as incentive programs often offer ‘tiered redemption’ with higher conversion rates of points to excisable value when more points are redeemed in one transaction; and (2) use the higher value excised from the incentive program when matching to the third-party donor, thus ensuring more added value than if the shopper and donor redeemed their rewards points separately at slightly worse conversion rates. For example, one redemption program for incentive points may offer a gift card of $25 for redeeming 100 points and a gift card of $55 for 200 points.

The shopper earns incentives 330 via the resources, promotions, and links available on the platform 110 or through other means. Regardless, the platform 110, in ideal embodiments, is capable of checking earned incentives from outside, unpartnered (or otherwise associated) sources and facilitating the shopper's donation of their earned incentives to at least one donation recipient 194 in an optimized and amplified manner. Moreover, the platform 110, in ideal embodiments, may operate its own incentive programs funded in part or in whole by merchant system 120 compensation (such as affiliate commissions, transaction and/or processing fees on specific payment methods it provides to users, or other financial instruments it may make available to users).

The platform 110 may include data related to the incentive redemption offers such as third-party match rates with the shopper's donation, what promotions are being used for the shopper's donation, whether the shopper's donation has additional, enhanced, or inflated rewards from the incentive program owner(s), the aggregated donation made to the donation recipient 194 including the shopper's donation, and estimated tax benefits from making the donation. It should be understood that steps 325 and 330 are interchangeable as are other steps within the method for amplifying the donation of incentives from shoppers 300.

The platform 110 provides the shopper with a selection of donation recipients 194 via at least one donation recipient selection module 335. This donation recipient selection module may be the module from the loyalty system 130 or, as previously described, the distinct donation recipient selection modules could be a singular module that is used by both systems. In further embodiments, the module may provide the shopper with a means for adding an unlisted donation recipient 194. The addition of this unlisted donation recipient 194 may require the submission of details about that potential donation recipient 194 such as their name, state and/or federal identification, residence or state of incorporation, account details for receiving any form of incentive donation, mailing address, etc.

Having reviewed the available options, the shopper makes their donation of incentives via the incentive redemption module 340.

The shopper's donation is added to the platform's at least one escrow account containing donations for the shopper's selection donation recipient 345. In some embodiments, the platform 110 may search for and/or negotiate better match rates and/or caps of paired or matched donations from third parties when the platform 110 aggregates multiple shoppers' donated incentives for a single donation recipient 194. This search and/or negotiation is a key factor in “amplifying” or “enhancing” the donation.

In some embodiments, as allowed by law, the shoppers, donors, and third-party donors' donations held in escrow accounts may accrue interest. In further embodiments, this interest earned by holding value (money, rewards points, incentives, property, etc.) in any escrow account may be used to incentivize donations and/or applied to amplify and/or enhance any donation made to one or more of the donation recipients 194.

Having achieved the most satisfactory amplified donation, the platform causes the donation to be sent to the donation recipient and the donors are notified of the donation details 350. Donation details may include the shopper/donor's donation amount, the match rate of third parties, the total and/or aggregated donation made to the donation recipient 194, details about the donation recipient 194, details about the third-party donors, details regarding the donation recipient's 194 plan for using the donation, tax information for the donation, and more.

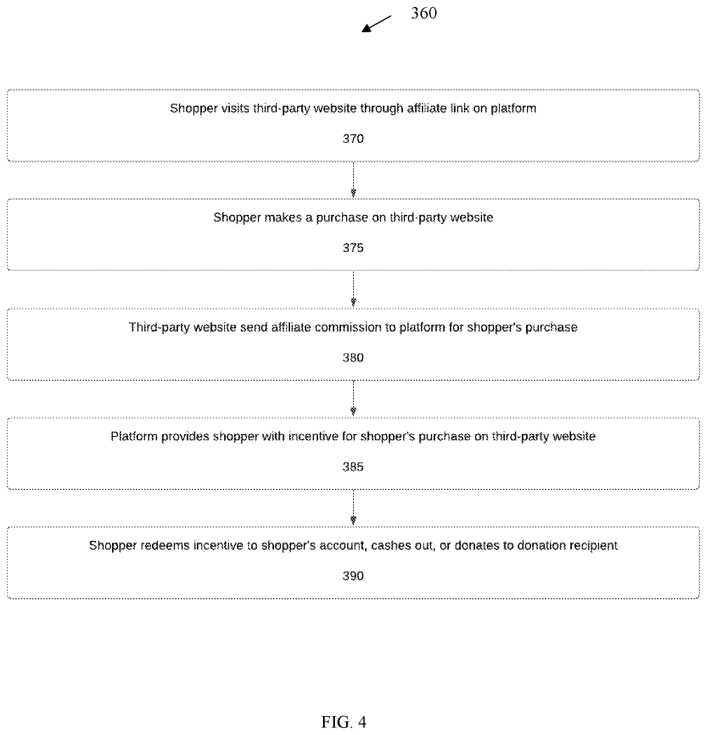

FIG. 4 is an exemplary method of how the shopper may use the platform. Whether the shopper registers an account on the platform 110 or not, the use of affiliate links present on the platform 110 enables the shopper to visit third-party websites to engage in commerce 370 while the activity is reported to and benefits the platform 110. In the present method, the shopper makes a purchase of a good and/or service on the third-party website that was accessed via the platform's 110 affiliate link 375. The third-party website sends the platform 110 a commission and/or other incentive reward for the shopper's purchase 380.

In some embodiments, the platform 110 provides some portion of the commission or incentive reward that the platform 110 received for the shopper's purchase on the third-party website 385. This portion may be provided for the shopper to use as an incentive which the shopper may be able to cash out and/or donate to one of the donation recipients 194. Also, the platform 110 may retain a portion of the commission or incentive reward to use as funds for amplifying donations via the donation amplifying system 160. Further, the platform 110 may require the shopper to donate this provided incentive, which was originally given to the platform 110 and not directly to the shopper from the third-party website thanks to the affiliate link commission.

Finally, in some embodiments, the shopper chooses whether to redeem the incentive to the shopper's account(s), cash out the incentive, or donate the incentive to a donation recipient 390. Again, the platform 110 may decide the portion of the incentive generated by the affiliate link commission as well as what the shopper's options are for redeeming and/or donating said incentive. In ideal embodiments, the platform 110 encourages the shopper to donate the incentive as part of an amplified donation.

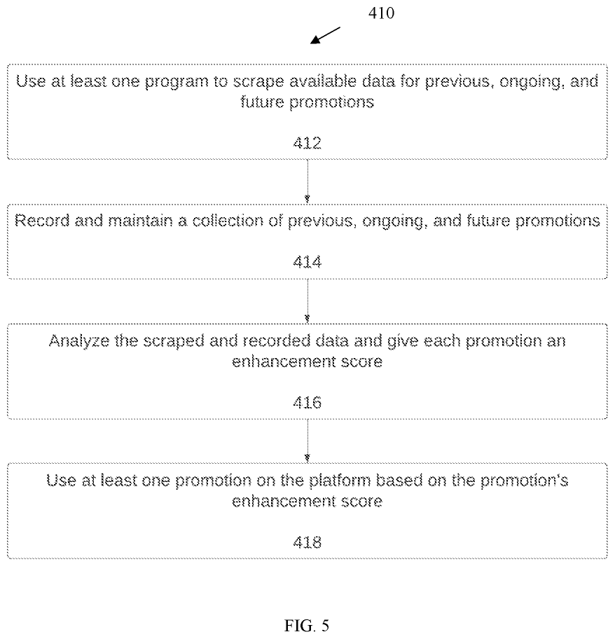

FIG. 5 is an exemplary method for scraping data to offer promotions to users of the platform. In some embodiments, a promotion scraping method 410 begins when the platform 110 causes (either automatically or manually) at least one computer program to scrape available data from previous, ongoing, and future promotions 412 including donation promotions, and, more specifically, also donation matching promotions. The computer program to scrape available data (or “the program”), in some embodiments, is part of the promotion search module 151. Further, the program usually focuses on scraping data from online, publicly available resources (or “online resources”) such as webpages, emails, web search results, metadata, and other resources that are either present or historic. The program may contain software, rules, routines, and/or algorithms designed to identify, classify, evaluate, and record found donation promotions available online. Some relevant data that may be scraped by the program includes URL(s), text, images, videos, rules, regulations, guidance, durations, deadlines, match rates, minimum and maximums, thresholds, and other data surrounding the promotion as well as data about the person or group running the promotion and their affiliates.

Once the data is scraped, the program records and maintains the collected data of donation promotions 414. In most cases, the data is recorded within at least one of the platform's 110 databases 111. This database 111 may be accessed by operators or other modules and systems within the platform 110.

The data for donation promotions within the database 111 is then analyzed and each donation promotion is assigned an enhancement score 416. This enhancement score is a reference for the platform 110 to evaluate whether any specific promotion is advantageous to offer users. Put another way, the enhancement score may be viewed as the likelihood that a specific promotion will “enhance” at least one user's donation. This evaluation may be automated by a specialized piece of software with rules or that is trained to evaluate the scraped data regarding one of the promotions by weighing several data points or factors against operator, affiliate, third party, and/or user preferences as well as other considerations (like lowering the selectiveness of the criteria for evaluation when the platform 110 seeks to offer a larger number or specific types of promotions). The evaluation may also include final approval for any promotion by one of the platform's 110 operators before being available to users. In alternative embodiments, the evaluation process may be mostly handled by at least one operator who may use software tools to assist with the evaluation.

In some embodiments, once at least one promotion has been analyzed, the platform 110 may use at least one promotion on the platform based on that promotion's enhancement score 418. The promotion may be featured generally or the platform 110 may employ marketing and/or other user-focused techniques such as cookie collection and integration of user data with third parties to offer each user featured promotions that are tailored to their interests. Alternatively, the platform 110 may not feature any publicly marketed and/or disclosed promotions to users or anyone else, choosing to apply the promotions as applicable (ideally to create the largest aggregate donations for one or more donation recipients 194).

However, in many alternative embodiments, the promotion information gathered by the platform 110 may not be presented to shoppers and donors. Instead, the platform 110 may merely advertise the amplified donation as an incentive for shoppers and donors to donate. Then, once the shoppers and/or donors have made their donations, the platform optimizes those donations through the donation amplifying system 160 which will use the found and analyzed promotions. Generally, optimizing promotions means generating the highest yield of value among one or all donation recipients 194 from donations and other considerations from shoppers, donors, and third-party donors. However, the platform 110 may set minimums that each donation recipient 194 must receive regardless of creating the highest yield. In this case, the platform 110 will attempt to optimize the highest yield of donations while or after meeting those minimums. Optimizing the excisable value (financial or otherwise) for any amount and/or kind of donation (including matching funds) may include contemplating factors such as charity efficiency coefficients, fundraising efficiency ratios, etc., and other intangibles in addition to traditional optimizations focused on generating the largest monetary donation that could be made.

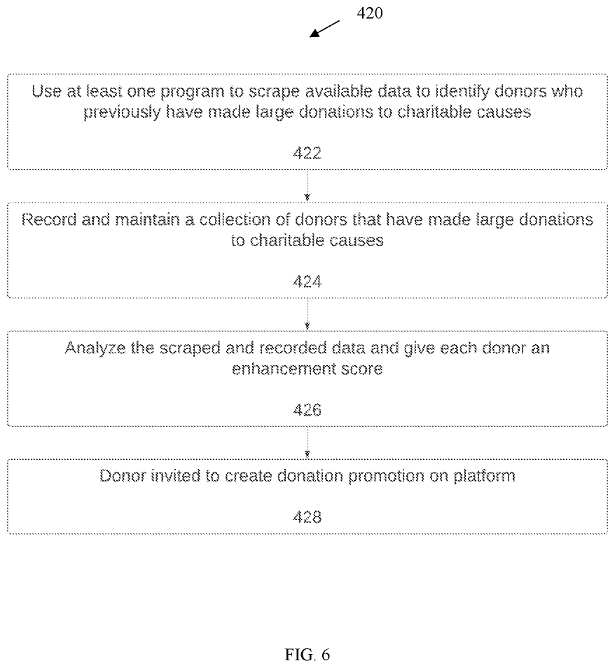

FIG. 6 is an exemplary method for scraping donor data to offer promotions to users of the platform. In some embodiments, a donor data scraping method 420 begins when the platform 110 causes (either automatically or manually) at least one computer program to scrape available data to identify donors who previously made large donations to charitable causes 422. The computer program to scrape available data may be a tool within the promotion search module 151. Further, the program usually focuses on scraping data from online, publicly available resources such as webpages, emails, web search results, metadata, and other resources that are either present or historic. More particularly, this program may focus on searching for available public disclosures (public statements, finance reports, tax forms and data, etc.) from individuals, groups, or companies regarding their philanthropic activities, promotions, and donations. The program may contain software, rules, and/or algorithms to identify, classify, evaluate, and record found donors and donation data. A “large donation” may be a relative term and the platform 110 may have a sliding scale of criteria based on the type and/or size of the donating entity, the time of donation, the type of donation, and the amount of the donation among other factors. Alternatively, the platform 110 may set a minimum donation amount to be classified as a “large donation.”

Once the data is scraped, the program records and maintains the collected data of donors and their large donations to charitable causes 424. Similar to steps in the promotion scraping method 410, the donor data scraping method 420 records and maintains records for the data within the platform's 110 at least one database 111. This includes recording and maintaining data related to the donors such as their name, state of residence or incorporation/corporate office, contact information, etc. and the donations such as the amount, frequency, if it were part of some sort of campaign or promotion, etc.

The data about donors with large donations within the database 111 is then analyzed and each donor is assigned an enhancement score 426. This enhancement score is a reference for the platform 110 to evaluate whether any specific donor is likely to donate again or partner/affiliate with the platform 110 to donate and/or match donations from shoppers. This evaluation may be automated by a specialized piece of software with rules or that is trained to evaluate the scraped data regarding the donors by weighing several data points or factors against operator, affiliate, third party, and/or user preferences as well as other considerations. The evaluation may also include final approval for any donor by one of the platform's 110 operators before being invited to publicly donate or match donations with shoppers. Of course, contacted donors are always welcome to donate anonymously and without visibility heightening by the platform 110. In alternative embodiments, the evaluation process may be mostly handled by at least one operator who may use software tools to assist with the evaluation.

Once at least one donor has been analyzed and selected, one of the agents of the platform 110 may reach out to the donor for solicitations of donations and/or matching donations with users. If approved by the donor, the platform 110 may further ask if the donor would like to create a donation promotion on the platform 428. This donor featuring invitation may benefit the donor by giving their donations visibility to drive users, non-users, and third-party donors to the platform 110 as well as provide what may sometimes be called “social credit.” Further, by securing donors to match user donations, the platform 110 may offer its users novel and unique donation promotions by using the solicited donations from these donors to amplify and/or enhance the shoppers' donations made to donation recipients 194.

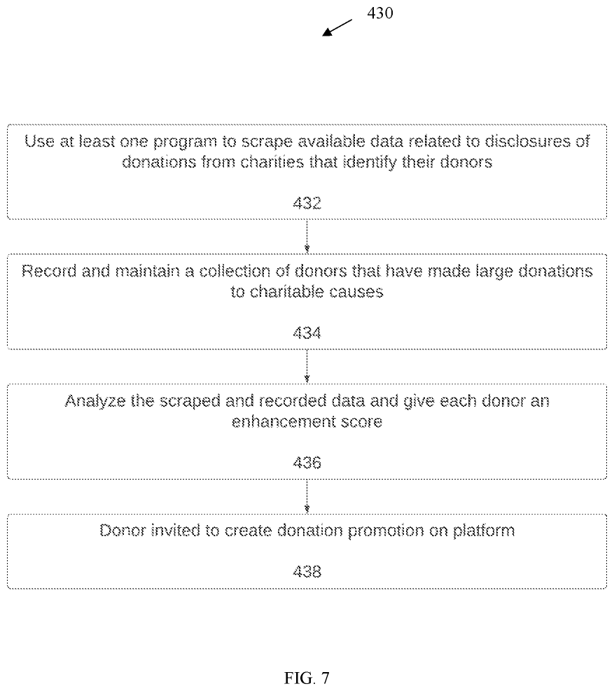

FIG. 7 is an exemplary method for scraping donation data provided by charitable organizations to offer promotions to users of the platform. In some embodiments, a charity donation data scraping method 430 begins when the platform 110 causes (either automatically or manually) at least one computer program to scrape available data from financial disclosures of charities to identify donors who previously made large donations to those charities 432. The computer program to scrape available data may be a tool within the promotion search module 151. Further, the program usually focuses on scraping data from online, publicly available resources such as webpages, emails, web search results, metadata, and other resources that are either present or historic. More particularly, this program may focus on searching for available public disclosures (public statements, finance reports, donation reports, tax forms and data, etc.) from charities (who usually have required reporting regulations). The program may contain software, rules, and/or algorithms to identify, classify, evaluate, and record found donors and donation data.

Once the data is scraped, the program records and maintains the collected data of donors and their large donations to charitable causes 434. Similar to steps in the promotion scraping method 410, the charity donation data scraping method 430 records and maintains records for the data within the platform's 110 at least one database 111. This includes recording and maintaining data related to the charities and their donors such as their name, state of residence or incorporation/corporate office, contact information, etc. and the donations such as the amount, frequency, if it were part of some sort of campaign or promotion, etc.

The data about donors with large donations within the database 111 is then analyzed and each donor is assigned an enhancement score 436. This enhancement score is a reference for the platform 110 to evaluate whether any specific donor is likely to donate again or partner/affiliate with the platform 110 to donate and/or match donations from users. This evaluation may be automated by a specialized piece of software with rules or that is trained to evaluate the scraped data regarding the donors by weighing several data points or factors against operator, affiliate, third party, and/or user preferences as well as other considerations. The evaluation may also include final approval for any donor by one of the platform's 110 operators before being invited to publicly donate or match donations with users. Of course, contacted donors are always welcome to donate anonymously and without visibility heightening by the platform 110. In alternative embodiments, the evaluation process may be mostly handled by at least one operator who may use software tools to assist with the evaluation.

Once at least one donor has been analyzed and selected, one of the agents of the platform 110 may reach out to the donor for solicitations of donations and/or matching donations with users. If approved by the donor, the platform 110 may further ask if the donor would like to create a donation promotion on the platform 438. This donor featuring invitation may benefit the donor by giving their donations visibility to drive users, non-users, and third-party donors to the platform 110 as well as provide what may sometimes be called “social credit.”

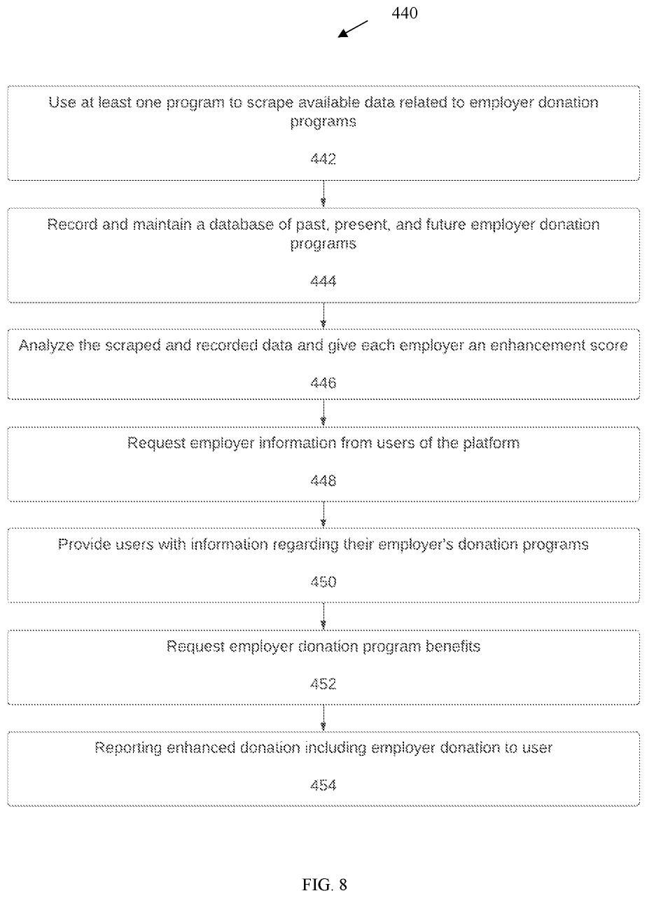

FIG. 8 is an exemplary method for obtaining employer promotion data and assisting users of the platform in benefiting from donation programs provided by their employers. In some embodiments, an employer donation data scraping method 440 begins when the platform 110 causes (either automatically or manually) at least one computer program to scrape available data related to employer donation programs 442. The computer program to scrape available data may be a tool within the promotion search module 151. Further, the program usually focuses on scraping data from online, publicly available resources such as webpages, emails, web search results, metadata, and other resources that are either present or historic. More particularly, this program may focus on searching for available public disclosures (public statements, finance reports, donation reports, tax forms and data, etc.) from employers (who usually have required reporting regulations after the employers reach a certain size and/or income). The program may contain software, rules, and/or algorithms to identify, classify, evaluate, and record found employer donations and/or programs.

Once the data is scraped, the program records and maintains the collected data of employer donation programs 444. Similar to steps in the promotion scraping method 410, the employer donation data scraping method 440 records and maintains records for the data within the platform's 110 at least one database 111. This includes recording and maintaining data related to the employers such as their name, state of residence or incorporation/corporate office, contact information, etc. and the donations such as the amount, frequency, if it were part of some sort of campaign or promotion, etc.

The data about employers and their donation programs within the database 111 is then analyzed and each employer and/or employer donation program is assigned an enhancement score 446. This enhancement score is a reference for the platform 110 to evaluate whether any specific employer and/or employer donation program is likely to donate again or partner/affiliate with the platform 110 to donate and/or match donations from users who are employees of that employer. This evaluation may be automated by a specialized piece of software with rules or that is trained to evaluate the scraped data regarding the employers by weighing several data points or factors against operator, affiliate, third party, and/or user preferences as well as other considerations. The evaluation may also include final approval for any employer by one of the platform's 110 operators before being invited to publicly donate or match donations with users. Of course, contacted employers are always welcome to donate anonymously and without visibility heightening by the platform 110. In alternative embodiments, the evaluation process may be mostly handled by at least one operator who may use software tools to assist with the evaluation.

Once at least one employer and/or their employer donation program has been analyzed and selected, one of the agents of the platform 110 may reach out to the employer for solicitations of donations, matching donations with users, and/or featuring the employer's donation program on the platform 110. If approved by the employer, the platform 110 may further ask if the donor would like to be featured on the platform 110. This employer featuring invitation may benefit the employer by giving their donations visibility to drive users, non-users, and third-party donors to the platform 110 as well as provide what may sometimes be called “social credit.”

In some embodiments, prior to any user completing their donation (direct donations or incentives) to at least one donation recipients 194, the platform 110 may request employer information from the user 448. This request for employer information is to determine whether the user qualifies for any known employer donation programs.

If the user's employer has an employer donation program (either already affiliated with the platform 110 or separate), the platform 110 will provide users with information about their employer's donation programs 450. Once the user has submitted the necessary information, the platform 110 will notify the employer and request the benefits and/or donations from that employer's donation program 452.

Further, the platform 110 may provide the user with the ability to add their employer's donation program to the platform 110 (pending an approval process). Even further, the platform 110 may provide the user with incentive donation paperwork which the user could then take to their employer themselves to participate in the employer's donation programs. Optionally, the platform 110 may request the user provide documentation of their participation and the amplified or enhanced donation created by their employer's donation program. This would allow the platform 110 to report a more accurate amplified or enhanced donation to its users by adding in additional donations made by employers who do not report to or work directly with the platform 110.

After confirmation that the employer donation program has made its contribution to the donation recipient 194 via the platform 110 or alone, the platform 110 will report the amplified or enhanced donation including the employer's donation 454.

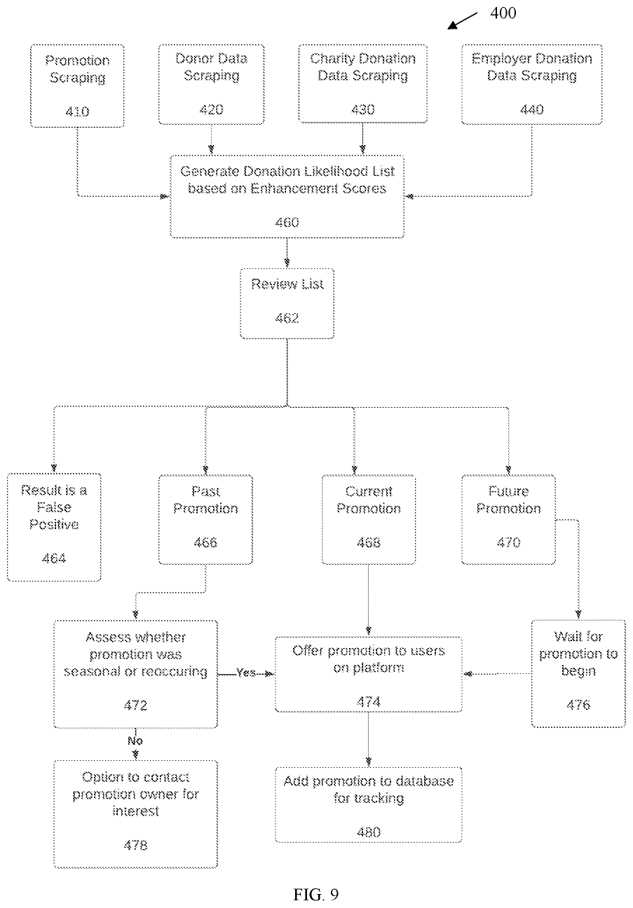

FIG. 9 is an exemplary method for finding, tracking, evaluating, and providing users of the platform with at least one donation promotion. In some embodiments, a promotion search method 400 includes generating a list of likely donors, employer participants, and donation promotions based on their enhancement scores 460. These enhancement scores are generated by at least one method from promotion scraping methods 410, donor data scraping methods 420, charity donation data scraping methods 430, employer donation data scraping methods 440, and combinations thereof. The enhancement scores given to each donor, employer, and/or donation program will highlight the likelihood that the scored person, group, entity, or program will participate in the platform's 110 endeavors. “Donor” as used by the donor data scraping method 420 and charity donation data scraping method 430 includes both donors who will donate to the at least one donation recipient 194 through the donor system 140 and third-party donors who are solicited or have other donation arrangements with the platform 110 so that the platform 110 can offer their pledged and/or matched donations to incentivize shopper and/or other donor donations.

The list of enhancement scores is reviewed 462. It is determined whether the enhancement score was a false positive 464, the promotion has expired 466, the promotion is ongoing 468, or the promotion has yet to begin 470. The review of the list of enhancement scores may be done manually or by software.

If the enhancement score is a false positive 464, the platform 110 may use that data to refine their method and/or reinforce and strengthen future algorithm performances by highlighting reasons why the false positive occurred.

If the promotion has expired 466, the platform 110 will assess whether the promotion was seasonal or reoccurring 472. If the promotion was seasonal or reoccurring, the platform 110 may still offer the promotion to users 474. In this case, the platform 110 may collect donations for a future season or occurrence of that promotion by holding the donated funds within at least one of the platform's escrow accounts 193 until the promotion is once again available. When required, the platform 110 may inform the user of this delay in the processing of their donation. If the promotion was not seasonal or reoccurring, the platform 110 may reach out to that promotion's owner to gauge interest in either reopening the promotion or offering another promotion featured on the platform 478.

In some embodiments, the platform 110 may earn interest on the funds held in escrow. In such embodiments, the platform 110 may donate either immediately or by holding and using the earned interest to incentivize shoppers and/or donors to make a matching and/or amplified donation.

Current/ongoing promotions 468 are offered to users of the platform 474 barring any extenuating circumstances which may give the platform 110 a reason to delist and/or expunge the promotion.

Future promotions 470 are tracked and added to the platform once they begin 476. In some cases, future promotions may be advertised on the platform prior to their start date. The platform 110 may or may not put a hold on or collect donations for future promotions.

Promotions that are offered on the platform to users are added to the promotion database for tracking purposes 480. This list may include data related to promotion owners, promotion match rates, promotion minimums, caps, and thresholds, promotion terms, whether a promotion is seasonal or reoccurring, the intended donation recipient 194 for any promotion, etc.

In one exemplary embodiment, the enhancement scores are filtered from highest score to lowest and an agent of the platform 110 selects the highest twenty enhancement scores to feature on the platform as donation matching programs and/or promotions. In an alternative exemplary embodiment, the list of enhancement scores (or a variation thereof) may be provided to users as users select which donation programs to participate in on the platform 110. In further embodiments, the platform may present the user with tailored donation program suggestions based on enhancement scores among other factors such as maximizing (“amplifying”) the donation amount by changing the user's incentive redemption method (for example, the user converting loyalty points to gift cards before donating them instead of merely donating the loyalty points, if performing such a conversion would result in a larger donation).

In some embodiments, all outcomes of the promotion search method result in the data being relayed back to at least one program that continues to refine the method (such as an algorithm trained to optimize the method and its various steps). Particularly, in ideal embodiments, the refinement is focused on maximizing match rates, donation amounts, user engagement, third party and/or promotion owner engagement and participation, types of donation recipients, and other desirable factors for stimulating the donation of incentives to donation recipients 194.

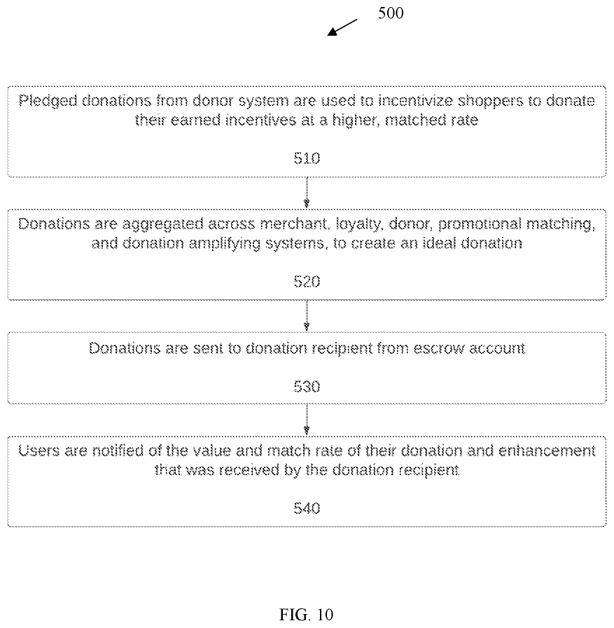

FIG. 10 is an exemplary method of donation amplification for shopper donations made via the platform. In some embodiments, a donation amplification method 500 begins by using donations (pledged or received) to incentivize shoppers to donate their earned incentives at a higher, matched rate 510. These pledged donations may come from larger entities such as businesses and companies who may simply provide a donation fund (with or without a stipulated match rate), a match rate, or a donation promotion or campaign with specified terms and conditions. These pledged donations may also come from individuals of various incomes and net worths. In fact, a large portion of any donated fund from similar systems are, in fact, the aggregation of donations of smaller, individual donors. These donors of pledged donations are considered third-party donors in some cases by the donation amplifying system 160. Shoppers of the platform 110 are incentivized to donate their earned incentives using the platform 110 because these pledged donations will match with the shopper's donation, thereby “amplifying” or “enhancing” the shopper's donation to a larger amount for the donation recipient 194. For example, a donor or third-party donor may have provided a pledge (possibly including an authorization to deduct the pledged funds, incentives, points, etc.) for $20 in gift cards redeemed through a credit card's points redemption program and once the shopper donates a compatible $20 donation the platform 110 will amplify the shopper's donation with the donor's donation to create the amplified $40 donation. The donation may be further amplified or enhanced by the shopper's interactions and any third party's participation with the merchant system 120, loyalty system 130, donor system 140, promotional matching system 150, and donation amplifying system 160.

Earned, collected, and/or received donations are aggregated and/or amplified across loyalty, donor, and promotional matching systems using the donation amplifying system to create an ideal donation 520. The ideal donation most often means the highest monetary value, meaning creating the maximum usable fund for the donation recipient 194 to effectively use. Often, creating the highest monetary value means pooling shopper, donor, and third-party donor donations (in all forms) and converting the various types of donated incentives into a single form. Alternatively, sometimes the ideal donation may take a non-cash form of value, such as airline miles or hotel accommodations. The platform 110 and/or the donation recipient 194, in some embodiments, may dictate or request the form of the aggregated donation.

Once the aggregated donation is settled into at least one form, the platform may send the donation to the donation recipient from the platform's escrow account 530. The platform 110 may require the donation recipient 194 to accept donations in at least one specified form for the donation recipient 194 to be eligible to receive donations via the platform 110. Further, the platform 110 may allow the donation recipient 194 to receive donations as pre-paid gift or debit cards (physical or digital), removing the need for the donation recipient to provide bank account and routing numbers.

After the aggregated donation is made to the donation recipient 194, users are notified of the value and match rate of their donation and the amplification or enhancement that was received by the donation recipient 540. This data provides the user with (1) their expected tax benefit and (2) their effective donation made when considering the match rate and/or donation amplification or enhancement.

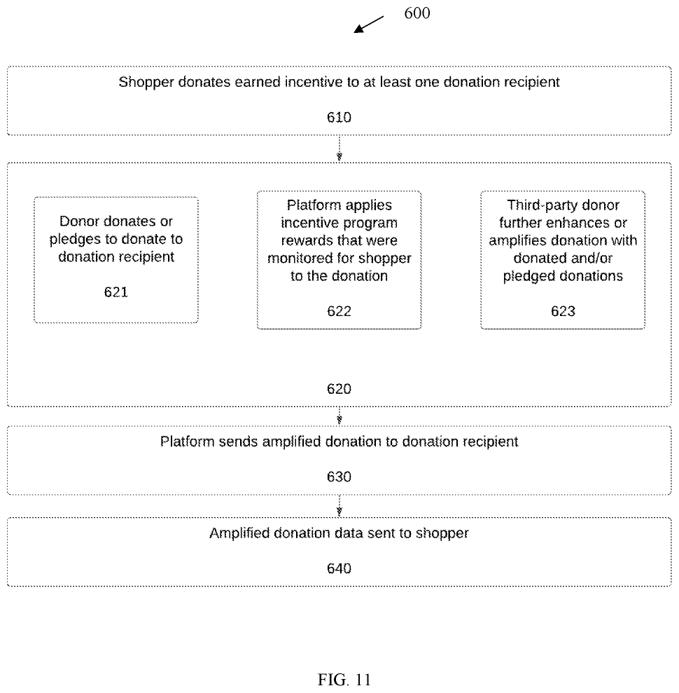

FIG. 11 is an exemplary method of amplifying a shopper's incentivized donation. This exemplary method for amplifying a shopper's donation 600 assumes that the shopper has already earned incentives as previously described wherein they used affiliate links on the platform 110 to generate the incentives or supplied information to make their incentives donatable via the platform 110, whether this includes registering an account with the platform or not. Further, this exemplary method, for illustrative purposes, assumes that the shopper has elected to donate their earned incentives instead of redeeming those incentives for the shopper's own benefit or to the shopper's account.

The shopper donates their earned incentive(s) to at least one donation recipient 610 via the shopper donation recipient selection module 135. This donation is then amplified and/or enhanced with the donation amplification method 620 via the donation amplifying system 160. This amplification and/or enhancement of the donation is accomplished by: (1) pairing the shopper's donation with donations from donors to the same donation recipient 621; (2) applying any additional incentives the platform monitors for the shopper and that the shopper has authorized to be used for donations 622 (such as third-party incentive programs); and (3) applying third-party donations to the aggregated donation between the shopper, donor, and third-party donor. The donation pairing from donor(s) 621 and third-party donor(s) 623 may be matched either as a condition of the donor's and third-party donor's donations or aggregated and reported as a matched donation when a matching donation from a shopper is not required. Again, the purpose generally being offering amplified donations values to shoppers to incentivize the donation of the shopper's earned incentives. There are often third-party incentive promotions (which may be one form of an incentive program) that the shopper is unaware of or did not sign up for which may be a benefit to the donation recipient 194; therefore, the platform 110 finds, reviews, evaluates, and attempts to apply these unused third-party incentive promotions to amplify the shopper's donation without any additional effort from the shopper. This method of monitoring and automatically applying third-party incentive promotion rewards on behalf of the shopper may require prior approval from the shopper, but such approval may be expressly given or may be implied through the shopper's use of affiliate links on the platform 110 or through the other methods that the platform 110 employs to track and/or receive compensation for the shopper's commercial activities.

Having aggregated the shopper's donation with other shoppers, donors, third-party donors, and incentives from monitored third-party incentive promotions, the platform sends this aggregated donation to the donation recipient 630. Once it is received, the amplified donation data is sent to the shopper 640 (as well as other interested parties). The shopper has been incentivized to have their donation matched by donors and third-party donors and all those involved have engaged in an effort to maximize financial and/or social impact for the intended donation recipient 194. In this example, the shopper gained a more valuable redemption opportunity for their rewards, and donors were able to elicit a larger donation amount sent to their donation recipient at no extra cost to themselves.

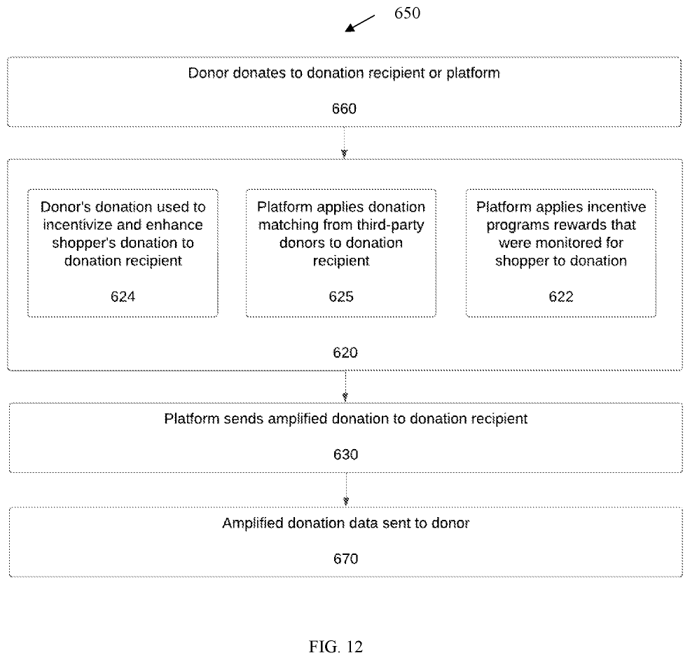

FIG. 12 is an exemplary method of using a donor's donation to incentivize and amplify a shopper's donation. As with the shopper of FIG. 11, the donor in this exemplary embodiment may have chosen to register an account (or not) with the platform 110. So long as legally required identification is supplied (if it is required at all), the donor need not concern themself beyond the fact that their donation was made and will be used to incentivize further donations from shoppers and third-party donors as part of the donation amplifying system 160. Thus, regardless of the foregoing, the method for using a donor's donation to incentivize and amplify a shopper's donation 650 begins when the donor donates (or, in some cases, pledges a donation) to a donation recipient 660 via the donor system 140 on the platform 110 or directly to a donation fund that is controlled by the platform 110. Most donors wish to select the donation recipient; however, the platform 110 may also accept donations for a general donation fund that is then used to incentivize shoppers to donate and/or match with other donations.

The donor's donation is then used for the donation amplification method 620 within the donation amplifying system 160 to incentivize and amplify/enhance a shopper's donation to the donation recipient 624 via the loyalty system 130. Also, the platform 110 will apply any found donation matching promotions, offers, incentives, etc. that it finds to match the donor's donation with the third-party donor's donation 625 (such as third-party incentive programs and given that one such match is found). Further, the donor's donation and others' donations will be used to incentivize the donation of incentive program rewards from shoppers as well as any monitored incentive program rewards 622 that are eligible to be applied to the aggregated donation.

Having aggregated the donor's donation with other shoppers, donors, third-party donors, and incentives from monitored incentive programs, the platform sends this aggregated donation to the donation recipient 630. Once it is received, the amplified donation data is sent to the donor 670 (as well as other interested parties). The donor has therefore, ideally, used their intended donation to incentivize and/or cause shoppers, third-party donors, incentive program providers, and other donors to donate, thereby causing financial and/or social impact to the donation recipient, community, country, world, or other scope of reach for the donation. By using the platform rather than making a direct donation, the donor may create a larger donation to their donation recipient at no extra cost to themselves. Further, value is generated for the shoppers who donate their earned incentives thanks to the donors and third-party donors aggregated and/or matching donations.

In some embodiments, at least one user (shopper or donor) may choose to assign at least one tax benefit of that user's donation to at least one tax beneficiary. The tax beneficiary may be another user, one of the third-party donors, merchants, providers, etc., the platform, or some other person or legal entity (including a charitable organization such as the donation recipient).

In some embodiments, the platform 110 may function as a facilitator of generating aggregated donations to send to donation recipients 194. In such embodiments, the platform 110 commands the ability (through agreements, mechanisms, APIs, etc.) to have the shoppers, donors, and third-party donors' pledged or given donations to be transferred either to an escrow account (not held by the platform) or directly to the donation recipient 194.

It should be understood that any of the examples described herein may include various other features in addition to or in lieu of those described above. By way of example only, any of the examples described herein may also include one or more of the various features disclosed in any of the various references that are incorporated by reference herein.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Having shown and described various versions of the present invention, further adaptations of the methods, systems, and apparatus described herein may be accomplished by appropriate modifications by one of ordinary skill in the art without departing from the scope of the present invention. Several such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for incentivizing and amplifying a donation of consumer incentive program rewards with third-party contributions, the system comprising:
at least one provider;
at least one user connected via at least one user device;
at least one merchant;
at least one donation recipient;
a platform comprising:
a network connection to the at least one provider, the at least one user, the at least one merchant, and the at least one donation recipient;
a merchant system operably connected to the at least one provider and the at least one merchant, and providing at least one method for at least one shopper to engage with the at least one provider and the at least one merchant;
a loyalty system that facilitates, engages with, and incentivizes the at least one shopper to donate the at least one shopper's earned incentive to the at least one donation recipient;
a donor system that facilitates a donation from a donor to the at least one donation recipient;
a promotional matching system that includes a promotion search module which finds, evaluates, scores, and records at least one promotion that may be used to aid the at least one shopper's accrual and donation of the at least one earned incentive to the at least one donation recipient;
a donation amplifying system for matching, amplifying, and optimizing the at least one shopper's donated at least one earned incentive by incentivizing the at least one shopper to make the donation through the platform in order to allow the donation amplifying system to combine at least two of: the shopper's donated at least one earned incentive, the at least one donor's donation, and at least one third-party donor's donation to create an aggregated donation that is greater than if the donor and third-party donor were to individually donate their respective donations without using the platform; and
a database.

2. The system for incentivizing and amplifying the donation of consumer incentive program rewards with third-party contributions of claim 1, wherein the merchant system further comprises an affiliate network module, a partner module, an affiliate links tool, a commission structure, and having access to at least one transaction database.

3. The system for incentivizing and amplifying the donation of consumer incentive program rewards with third-party contributions of claim 1, wherein the loyalty system further comprises a user commercial interface, a transaction reporting tool, a platform escrow account module, a shopper donation recipient selection module, and an incentive redemption module.

4. The system for incentivizing and amplifying the donation of consumer incentive program rewards with third-party contributions of claim 1, wherein the donor system further comprises a donor donation recipient selection module, a donation aggregation module, and a donor escrow account module.

5. The system for incentivizing and amplifying the donation of consumer incentive program rewards with third-party contributions of claim 1, wherein the donation amplifying system, via a donation matching module, calculates and causes the system to extract from at least one incentive program owner the largest excisable value that can be generated for the at least one donation recipient using the aggregated donations of the at least one shopper, the at least one donor, the at least one third-party donor, and optimizing the available at least one promotion that is applicable to the aggregated donation.

6. The system for incentivizing and amplifying the donation of consumer incentive program rewards with third-party contributions of claim 5, wherein the promotion search module causes the platform to:
scrape data from at least one online resource;
generate at least one list of potential donation programs, donation promotions, and incentive programs;
review the at least one list and classify each entry on the list;
assess whether any programs and promotions are ongoing and usable by the platform;
provide information and methods for the at least one user to access the approved ongoing and usable programs and promotions on the platform;
assess whether any programs and promotions are expired but reoccurring;
add details about the potential donation programs, donation promotions, and incentive programs to at least one database;
assign each potential donation program, donation promotion, and incentive program an enhancement score;
determine whether each potential donation program, donation promotion, and incentive program should have their information and method of access added to the platform for users to engage;
keep all enhancement score data in the at least one database;
incentivize at least one user to make a donation to the at least one donation recipient via the platform by offering an estimated value of the amplified donation;
hold the user's donation in at least one escrow account for a period; and
instruct the donation matching module to convert the user's donation to higher yielding excisable value if new incentive programs, promotions, and donation programs allow for those higher yielding excisable values during the period.

7. The system for incentivizing and amplifying the donation of consumer incentive program rewards with third-party contributions of claim 5, wherein the donation matching module causes the platform to optimize the matching funds from third-party donors to create the highest yielding excisable value across more than one donation recipients.

8. The system for incentivizing and amplifying the donation of consumer incentive program rewards with third-party contributions of claim 1, wherein the donation amplifying system maximizes the financial value of donations across more than one donation recipients.

9. The system for incentivizing and amplifying the donation of consumer incentive program rewards with third-party contributions of claim 1, wherein donations are transferred to the at least one donation recipient directly from the at least one shopper, the at least one donor, and the at least one third-party donor.

10. The system for incentivizing and amplifying the donation of consumer incentive program rewards with third-party contributions of claim 9, wherein the platform merely facilitates the donation of assets from the at least one shopper, the at least one donor, and the at least one third-party donor to the at least one donation recipient.

11. The system for incentivizing and amplifying the donation of consumer incentive program rewards with third-party contributions of claim 1, further comprising at least one financial institution operably connected with the platform over the network connection and wherein the at least one financial institution provides at least one escrow account to the platform to hold donations from the at least one shopper, the at least one donor, and the at least one third-party donor prior to sending those donations to the at least one donation recipient.

12. The system for incentivizing and amplifying the donation of consumer incentive program rewards with third-party contributions of claim 11, wherein the donations held in the at least one escrow account earn interest that is used to amplify the aggregated donation.

13. The system for incentivizing and amplifying the donation of consumer incentive program rewards with third-party contributions of claim 12, wherein the platform uses the earned interest from the at least one escrow account to incentivize the at least one user to donate to the at least one donation recipient.

14. The system for incentivizing and amplifying the donation of consumer incentive program rewards with third-party contributions of claim 11, wherein the donations held in the at least one escrow account are invested to generate a larger aggregated donation for the at least one donation recipient.

15. The system for incentivizing and amplifying the donation of consumer incentive program rewards with third-party contributions of claim 1, wherein at least one user assigns at least one tax benefit of the at least one user's donation to at least one tax beneficiary.

16. A method for incentivizing and amplifying a donation of consumer incentive program rewards with third-party contributions, the method comprising:
a platform providing a donor with at least one method for making a donation to at least one donation recipient via the platform;
the platform providing a third-party donor with at least one method for making a matching donation to the at least one donation recipient via the platform;
the platform providing a shopper with at least one form of a merchant system and at least one form of a loyalty system to engage with in order to generate an asset that may be donated to the at least one donation recipient;
the platform incentivizing the shopper to donate at least one earned incentive to the at least one donation recipient via the platform wherein at least one of: the donor's donation and the third-party donor's matching donation are used to incentivize the shopper to donate the shopper's at least one earned incentive to create an amplified aggregated donation;
the shopper donating the at least one earned incentive to the at least one donation recipient via the platform;
the platform aggregating at least two of: the shopper's donated at least one earned incentive, the donor's donation, and the third-party donor's matching donation to create the amplified aggregated donation; and
the platform causing the amplified aggregated donation to be sent to the at least one donation recipient.

17. The method for incentivizing and amplifying the donation of consumer incentive program rewards with third-party contributions of claim 16, wherein the one shopper's donated at least one earned incentive is used to incentivize another shopper to donate another at least one earned incentive.

18. The method for incentivizing and amplifying the donation of consumer incentive program rewards with third-party contributions of claim 16, wherein at least one of: the shopper's donated at least one earned incentive, the donor's donation, and the third-party donor's matching donation are held in at least one escrow account.

19. The method for incentivizing and amplifying the donation of consumer incentive program rewards with third-party contributions of claim 18, wherein the at least one escrow account earns interest on at least one held donation.

20. The method for incentivizing and amplifying the donation of consumer incentive program rewards with third-party contributions of claim 19, further comprising the step of the platform offering to donate the interest earned by the at least one escrow account to the at least one donation recipient to incentivize at least one shopper to make a donation to the at least one donation recipient.

21. The method for incentivizing and amplifying the donation of consumer incentive program rewards with third-party contributions of claim 18, further comprising the step of the platform investing the at least one held donation to ideally generate a larger donation to the at least one donation recipient.

22. The method for incentivizing and amplifying the donation of consumer incentive program rewards with third-party contributions of claim 16, wherein the shopper's donated at least one earned incentive includes some part of a commission given to the platform by the merchant associated with an affiliate link on the platform that the shopper used to access the merchant's website and the platform offering part of that commission to the shopper to use as the donation to the at least one donation recipient.

23. The method for incentivizing and amplifying the donation of consumer incentive program rewards with third-party contributions of claim 16, further comprising the steps of:
the user registering a user account with the platform;
the user providing details for at least one consumer incentive program that the user has enrolled in; and
the user authorizing the platform to communicate with an owner of that consumer incentive program about the user and the user's earned incentives and assets for donation.

24. The method for incentivizing and amplifying the donation of consumer incentive program rewards with third-party contributions of claim 16, further comprising the step of the platform offering the shopper to optimize the shopper's incentive redemptions from the shopper's at least one consumer incentive program in order for the platform to create an ideal donation for the at least one donation recipient.

25. The method for incentivizing and amplifying the donation of consumer incentive program rewards with third-party contributions of claim 24, wherein the ideal donation is generated by a donation amplification system directed, by the platform, to excise the largest extractable value from at least one incentive program using the amplified aggregated donation of at least two of:
the shopper, the donor, and the third-party donor.

26. The method for incentivizing and amplifying the donation of consumer incentive program rewards with third-party contributions of claim 16, wherein the amplified aggregated donation of at least two of: the shopper, the donor, and the third-party donor is leveraged by a donation amplification system to excise the largest extractable value from at least one incentive program.

27. The method for incentivizing and amplifying the donation of consumer incentive program rewards with third-party contributions of claim 16, further comprising the steps of the platform using at least one promotion search method to:
scrape data from at least one online resource;
generate at least one list of potential donation programs, donation promotions, incentive programs, donors, third-party donors, and employers with at least one donation program;
review the at least one list and classify each entry on the list;
assess whether any programs and promotions are ongoing and usable by the platform;
provide information and methods for users to access the approved, ongoing, and usable programs and promotions on the platform;
assess whether any programs and promotions are expired but reoccurring; and
add details about the potential donation programs, donation promotions, incentive programs, donors, third-party donors, and employers with at least one donation program to a database.

28. The method for incentivizing and amplifying the donation of consumer incentive program rewards with third-party contributions of claim 27, further comprising the step of the platform providing information and methods for users to access the expired but reoccurring programs and promotions once each program and promotion is once again valid and usable.

29. The method for incentivizing and amplifying the donation of consumer incentive program rewards with third-party contributions of claim 27, further comprising the steps of the platform:
offering to accept donations to at least one expired but reoccurring program and promotion;
receiving at least one donation for the at least one expired but reoccurring program and promotion from the user;
holding the at least one donation for the at least one expired but reoccurring program and promotion in at least one escrow account; and
redeeming the reoccurring program and promotion once it is again active so that the platform may provide the at least one donation to the user's desired at least one donation recipient.

30. The method for incentivizing and amplifying the donation of consumer incentive program rewards with third-party contributions of claim 27, further comprising the step of the platform contacting owners of previous donation programs and donation promotions, donors, third-party donors, and employers of at least one previous donation program to petition those owners, donors, and employers to initiate a new donation promotion on the platform.

31. The method for incentivizing and amplifying the donation of consumer incentive program rewards with third-party contributions of claim 27, further comprising the steps of the platform:
assigning each potential donation program, donation promotion, incentive program, donor, third-party donor, and employer with at least one donation program an enhancement score;
determining whether each potential donation program, donation promotion, incentive program, donor, third-party donor, and employer with at least one donation program should have their information and method of access added to the platform for users to engage; and
keeping all enhancement score data in the at least one database.

32. The method for incentivizing and amplifying the donation of consumer incentive program rewards of claim 16, further comprising the steps of:
the platform providing the at least one form of a loyalty system wherein the platform collects fees for at least one payment instrument used by the at least one shopper; and
the platform using at least a portion of the collected fees to incentivize the at least one shopper to donate their earned incentives to the at least one donation recipient.
